(19) United States
(12) Patent Application Publication
(10) Pub. No.: US 2007/0127764 A1
(43) Pub. Date: Jun. 7, 2007

(54) Earphone connector

(76) Inventor: Johnson Yang, Jhong-He City (TW)

Correspondence Address: CHARLES E. BAXLEY, ESQ., 90 JOHN STREET, THIRD FLOOR, NEW YORK, NY, 10038, US

(21) Appl. No.: 11/326,725

(22) Filed: Jan. 5, 2006

(30) Foreign Application Priority Data
Dec. 6, 2005 (CN) 094221144

(51) Int. Cl. H04R 25/00

(52) U.S. Cl. 381/384

(57) ABSTRACT

An earphone connector comprises a main body and a plurality of terminals. The terminals are formed on the main body separated from one another, and each saddle of the terminals is positioned in the locking portion of the main body respectively. Since the terminals are formed once, the terminals can be positioned to the main body stably so as to prevent the terminals from loosing. Thereby the quality of the products is improved and the life is prolonged.

### BACKGROUND OF THE INVENTION

1. Field of the Invention

The present invention relates to an earphone connector, and more particularly to an earphone connector that is easily assembled.

2. Description of the Prior Art

With the development of the science and technology, almost all electronic products with an earphone connector such as radio, walkman, computer and etc that can be changed to produce sound from the earphone instead of from the bugle. Therefore, earphone is an indispensable component of the electronic products. However, the structure of the earphone connector are various, how to develop an earphone which can be assembled easily and uneasier to fall off is one of the most important topics now.

Referring to FIG. 1, a conventional earphone connector comprises a main body 1 and a plurality of terminals 2. The main body 1 is formed with an inserting hole 101, a plurality of inserting slots 102 are located in the periphery of the inserting hole 101, which are vertical to the inserting hole 101. In the outer wall of the respective inserting slots 102 is formed a cavity 103. Each of the terminals 2 is irregular shaped and is formed with an engaging portion 201 at a side of the center portion of the terminals 2 thereof. One end of each terminal 2 is bended to form a connecting portion 202. The terminals 2 are inserted in the inserting slots 102 of the main body 1 and the connecting portion 202 are protruded out of the inserting slots 102 for connecting with the other objects electrically and the engaging portion 201 is engaged in the cavity 103 for positioning the terminal 2, thereby the earphone connector is assembled. However, this conventional earphone connector still has some deficiencies that need to be improved:

For inserting the terminals 2 in the inserting slots 102 of the main body 1 easily, the connecting portion 202 must be flat before being inserted. After the terminals 2 are inserted in the inserting slots 102 of the main body 1, the connecting portion 202 that protruded out of the inserting slots 102 to be bended. Thereby the assembling of the conventional earphone connector is troublesome, and since the earphone connector is becoming smaller, the connecting portion 202 is uneasily bended, which will cause damage to the connecting portion 202, also the terminals 2 are uneasier to fall off so as to reduce the quality of the products.

The present invention has arisen to mitigate and/or obviate the afore-described disadvantages.

### SUMMARY OF THE INVENTION

The primary objective of the present invention is to provide an earphone connector, the terminals of which can be positioned to the main body stably. A saddle can be formed simultaneously at the time the terminal is formed for assembling with the locking portion, so as to improve the quality of the products and prolong its life.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a conventional earphone connector;

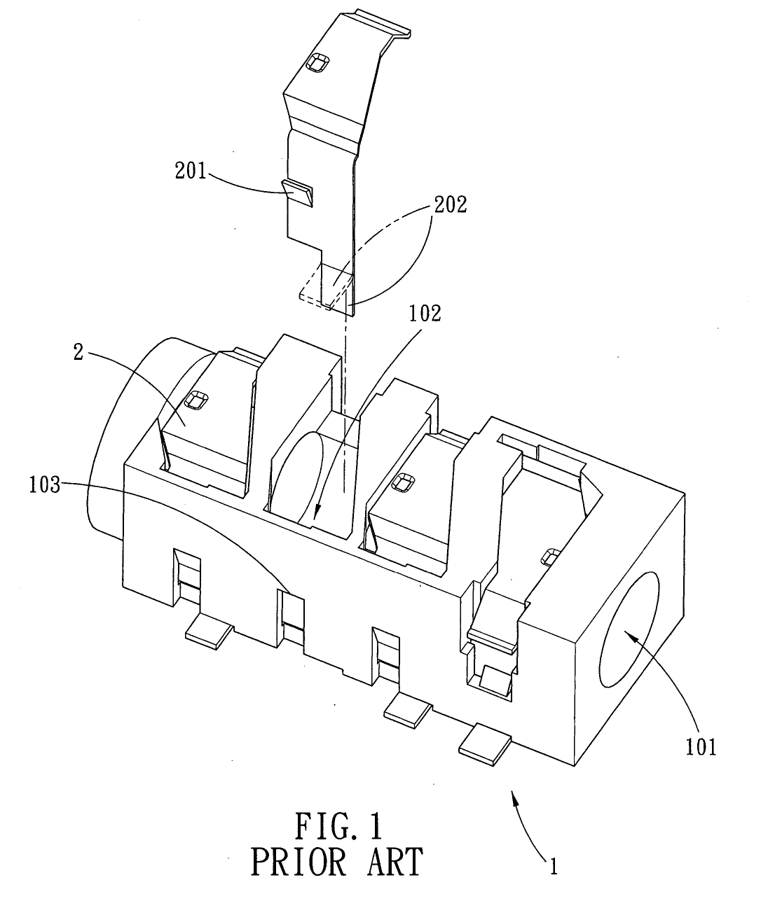

FIG. 2 is an exploded view of showing a main body and a terminal of an earphone connector in accordance with the present invention;

FIG. 3 is a perspective view of showing the main body and the terminals to be assembling;

FIG. 4 is an assembly view of the main body and the terminals in accordance with the present invention; and

FIG. 5 is an assembly view of the other side of the main body and the terminals in accordance with the present invention.

### DETAILED DESCRIPTION OF THE PREFERRED EMBODIMENTS

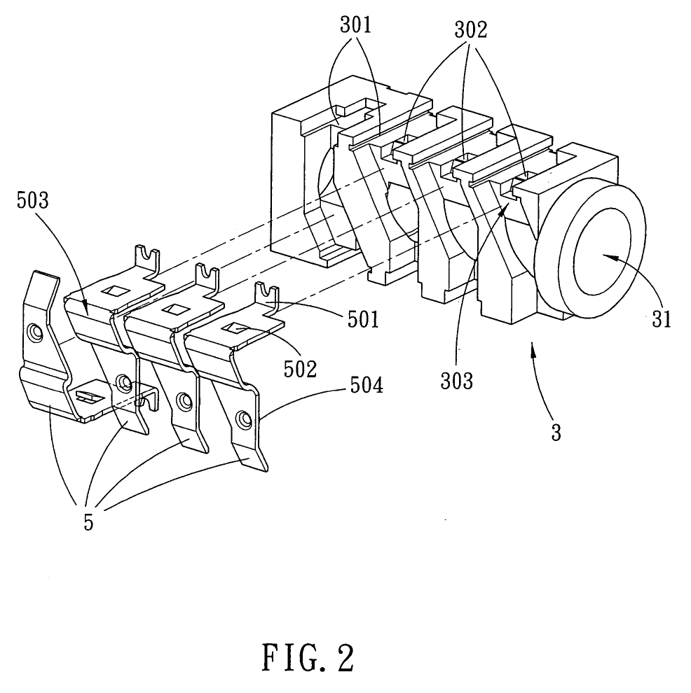

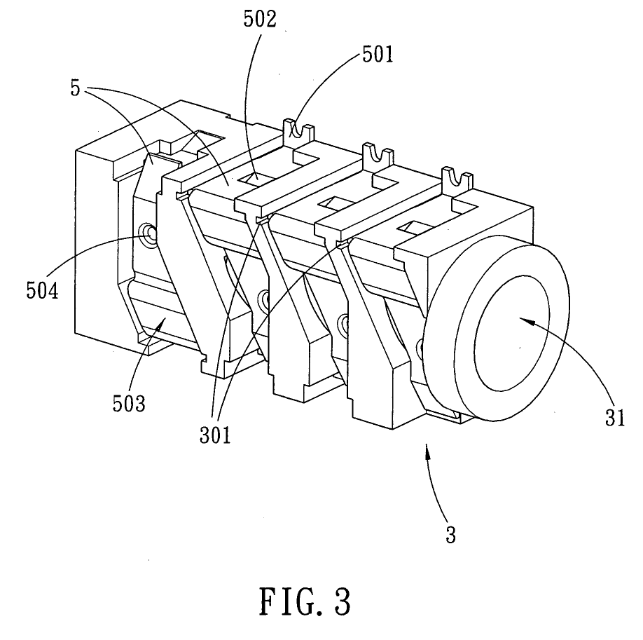

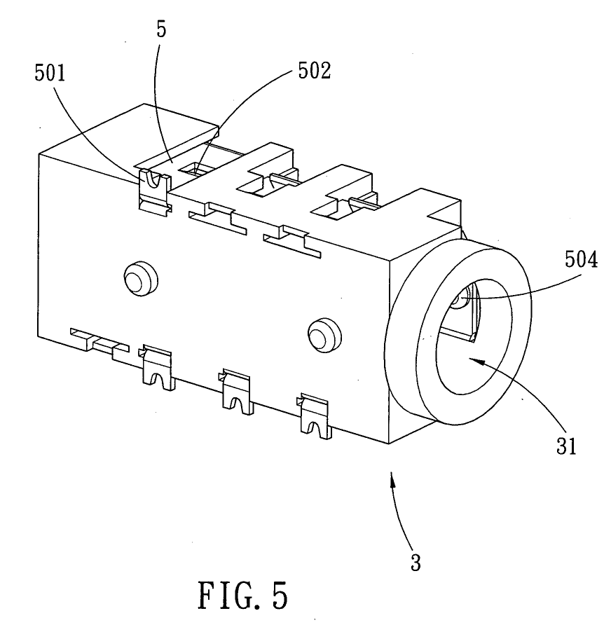

Referring to FIGS. 2-5, an earphone connector in accordance with the present invention comprises a main body 3 and a plurality of terminals 5, wherein:

The main body 3 is defined with an inserting hole 31, in the peripheral of the main body are formed a plurality of tracks 301 that are separated from one another. Each of the tracks 301 has two free ends, an engaging groove 302 is defined in each track 301, the respective engaging grooves 302 are separated from one another by the tracks 301. A locking portion 303 is formed adjacent to a surface of each engaging groove 302. It is noted that each engaging groove 302 is defined along the direction of the inserting hole 31, and the direction of the engaging groove 302 is vertical to that of the inserting hole 31.

The plurality of terminals 5, four terminals 5 are described in this embodiment, one end of each terminal 5 is bended to form a connecting portion 501, an engaging portion 502 is protruded out of the center of each terminal 5, and a protruded portion 504 is formed adjacent to the other end of the terminal 5, between the engaging portion 502 and the protruded portion 504 is formed a saddle 503, by such arrangement, the connecting portion 501 is located at the different direction of the engaging portion 502. While assembling, each terminal 5 is inserted in the track 301 of the main body 3, the engaging portions 502 are engaged with each engaging groove 302 of the main body 3 respectively, so that each saddle 503 is positioned in the locking portion 303 of the main body 3 respectively. Inserting the protruded portion 504 into the inner wall of each inserting hole 31, so that connecting portion 501 is still protruded out of the track 31.

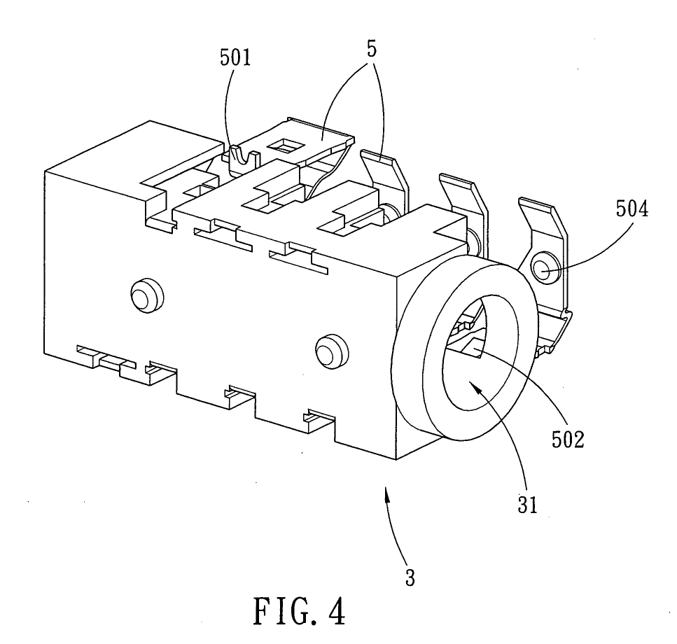

When assembling the terminal 5 to the main body 3, the terminal 5 can be inserted in the track 301 directly, and the engaging portion 502 of the terminal 5 can be engaged in the engaging groove 302 of the main body 3, and the saddle 503 is jointed to the locking portion 303 of the main body 3, so that the protruded portion 504 of the terminal 5 can be inserted in the inner wall of the inserting hole 31 of the main body 3 (as shown in FIG. 4) so as to connect with the earphone connector which is inserted in the main body 3. In other words, the connecting portion 501 of the terminal 5 can be bended to form predetermined before assembling, and the connecting portion 501 can be formed simultaneously at the time the terminal 5 is formed. By such arrangement, since the track 301 is cooperated with the engaging groove 302, the terminal 5 can be positioned on the main body 3 stably, and the protruded portion 504 of the terminal 5 can be inserted in the main body 3 more stably by cooperating the saddle 503 with the locking portion 303, so that after a long period the protruded portion 504 of the terminal 5 still can be connected with the earphone plug. Therefore, the assembling steps are simplified and the quality of the earphone plug can be improved. Particularly, this invention can avoid the problem of shaking of the terminal 5 and the main body 3, and needn't the process of bending the connecting portion 501 of the terminal 5 of the small main body 3.

While we have shown and described various embodiments in accordance with the present invention, it should be clear to those skilled in the art that further embodiments may be made without departing from the scope of the present invention.

What is claimed is:

1. An earphone connector comprising a main body and a plurality of terminals, wherein, the main body is defined with an inserting hole, in a peripheral of the main body are formed a plurality of tracks that are separated from one another, an engaging groove is defined in each track, each terminal is inserted in the track of the main body, and an engaging portion is protruded out of each terminal, the respective engaging portions are engaged with each engaging groove respectively, one end of each terminal is formed with a connecting portion, and a protruded portion is formed adjacent to the other end of the terminal,
a locking portion is formed adjacent to a surface of each engaging groove, a saddle is bended to form simultaneously at the time the connecting portion is formed, when assembling, each saddle is positioned in the locking portion of the main body respectively, and the protruded portion is inserted into the inner wall of each inserting hole.
